(19) United States
(12) Patent Application Publication
(10) Pub. No.: US 2025/0294025 A1
(43) Pub. Date: Sep. 18, 2025

(54) METHOD FOR EXPANDING PUBLIC CLOUD, DEVICE, SYSTEM, AND STORAGE MEDIUM

(71) Applicant: CLOUD INTELLIGENCE ASSETS HOLDING (SINGAPORE) PRIVATE LIMITED

(72) Inventors: Zhenhua ZHANG, Hangzhou (CN); Mingfeng HUANG, Beijing (CN); Yong REN, Beijing (CN)

(21) Appl. No.: 18/853,703

(22) PCT Filed: Apr. 7, 2023
(86) PCT No.: PCT/CN2023/086825

§ 371 Date: Jun. 9, 2025

(30) Foreign Application Priority Data
Apr. 15, 2022 (CN) 202210396407.5

(51) Int. Cl. H04L 9/40

(52) U.S. Cl. CPC H04L 63/0876; H04L 63/0245; H04L 63/0281; H04L 63/101

(57) ABSTRACT

Embodiments of the present application provide a method for expanding a public cloud, a device, a system, and a storage medium. In the embodiments of the present application, an expanded available zone is created for the public cloud, and the expanded available zone is deployed in a user machine room, so that a hardware facility of the public cloud is deployed to the user machine room in a software-hardware integration manner, which can meet requirements of users for data security, data local processing, low latency, etc. By managing the expanded available zone into the public cloud, the users can locally have usage experience that is consistent with that of the public cloud, and a boundary of the public cloud is expanded.

### CROSS-REFERENCE TO RELATED APPLICATIONS

The present application is a National Stage of International Application No. PCT/CN2023/086825, filed on Apr. 7, 2023, which claims priority to Chinese patent application No. 202210396407.5, filed to China National Intellectual Property Administration on Apr. 15, 2022 and entitled “METHOD FOR EXPANDING PUBLIC CLOUD, DEVICE, SYSTEM, AND STORAGE MEDIUM” These applications are hereby incorporated by reference in their entireties.

### TECHNICAL FIELD

The present application relates to the field of cloud technologies, and in particular, to a method for expanding a public cloud, a device, a system, and a storage medium.

### BACKGROUND

A public cloud refers to providing an infrastructure, as a service, provided by a public cloud provider to the outside through the Internet. In such a service model, a user does not need to construct a data center by himself/herself, but can use an infrastructure such as a server, a storage, and a network by means of renting. A public cloud service is implemented by providing a virtual environment (such as a virtual machine), and a core attribute of the public cloud is that multiple users share a cloud infrastructure and the users are isolated from each other.

At present, with the increasing demand for public clouds, public cloud providers need to gradually expand boundaries of distributed clouds by taking the public clouds as centers. In processes of expanding the boundaries, how to ensure the security of the public clouds becomes an urgent problem to be solved.

### SUMMARY

Various aspects of the present application provide a method for expanding a public cloud, a device, a system, and a storage medium, so as to solve a security problem that may occur in a process of expanding the public cloud.

An embodiment of the present application provides a method for expanding a public cloud, where an expanded available zone is created for the public cloud, the expanded available zone is laid in a user machine room, and a security gateway is configured on the public cloud; the method is applicable to the security gateway, and includes:
receiving an authentication request initiated by a physical device in the expanded available zone, where the authentication request includes identity information of the physical device;
in a case that the identity information of the physical device is authenticated successfully, establishing a secure tunnel between the security gateway and the physical device;
managing the expanded available zone into the public cloud based on the secure tunnel.

An embodiment of the present application further provides a method for expanding a public cloud, where an expanded available zone is created for the public cloud, the expanded available zone is laid in a user machine room, and a security gateway is configured on the public cloud; the method is applicable to a physical device in the expanded available zone, and includes:
initiating, based on a gateway proxy program installed in the physical device, an authentication request to the security gateway configured on the public cloud, where the authentication request includes identity information of the physical device;
in a case that the identity information is authenticated successfully, establishing a secure tunnel between the security gateway and the physical device;
diverting, based on the gateway proxy program, traffic initiated by the physical device for the public cloud to the secure tunnel to manage the expanded available zone into the public cloud through the secure tunnel.

An embodiment of the present application further provides a gateway device, deployed in a public cloud, where an expanded available zone is created for the public cloud, the expanded available zone is laid in a user machine room, and the gateway device includes a memory, a processor, and a communication component;
the memory is configured to store one or more computer instructions;
the processor is coupled to the memory and the communication component, and is configured to execute the one or more computer instructions to:
receive an authentication request initiated by a physical device in the expanded available zone through the communication component, where the authentication request includes identity information of the physical device;
in a case that the identity information of the physical device is authenticated successfully, establish a secure tunnel between the security gateway and the physical device;
manage the expanded available zone into the public cloud based on the secure tunnel.

An embodiment of the present application further provides a physical device, where an expanded available zone is created for a public cloud, and the expanded available zone is laid in a user machine room; the physical device is located in the expanded available zone, and the physical device includes a memory, a processor, and a communication component;
the memory is configured to store one or more computer instructions for gateway proxy;
the processor is coupled to the memory and the communication component, and is configured to execute the one or more computer instructions to:
initiate, based on a gateway proxy program installed in the physical device, an authentication request to a security gateway configured on the public cloud, where the authentication request includes identity information of the physical device;
in a case that the identity information is authenticated successfully, establish a secure tunnel between the security gateway and the physical device;
divert, based on the gateway proxy program, traffic initiated by the physical device for the public cloud to the secure tunnel to manage the expanded available zone into the public cloud through the secure tunnel.

An embodiment of the present application further provides a system for expanding a public cloud, including a security gateway and an expanded available zone created for the public cloud, where the security gateway is deployed in the public cloud, and the expanded available zone is laid in a user machine room;
a physical device in the expanded available zone is configured to initiate an authentication request to the security gateway configured on the public cloud based on a gateway proxy program installed in the physical device, where the authentication request includes identity information of the physical device;
the security gateway is configured to: receive the authentication request; in a case that the identity information of the physical device is authenticated successfully, establish a secure tunnel between the security gateway and the physical device; and manage the expanded available zone into the public cloud based on the secure tunnel.

An embodiment of the present application further provides a computer-readable storage medium storing computer instructions, where when the computer instructions are executed by one or more processors, the one or more processors are caused to execute the aforementioned method for expanding the public cloud.

In the embodiments of the present application, the expanded available zone is created for the public cloud, and the expanded available zone is deployed in the user machine room, so that a hardware facility of the public cloud is deployed to the user machine room in a software-hardware integration manner, which can meet requirements of users for data security, data local processing, low latency, etc. By managing the expanded available zone into the public cloud, the users can locally have usage experience that is consistent with that of the public cloud, and the boundary of the public cloud is expanded. Taking the expanded available zone as an untrusted environment, identity authentication is performed on the physical device in the expanded available zone through the security gateway deployed in the public cloud, to establish the secure tunnel between the physical device in the expanded available zone and the security gateway, and to strictly verify inbound and outbound traffic between the expanded available zone and the public cloud based on the security gateway, so that the security of the process of expanding the public cloud can be ensured.

### BRIEF DESCRIPTION OF DRAWINGS

The accompanying drawings described herein are used to provide further understanding of the present application, and constitute a part of the present application. The illustrative embodiments of the present application and their descriptions are used to explain the present application, and do not constitute improper limitation to the present application. In the accompanying drawings:

FIG. 1 is a schematic logical diagram of a method for expanding a public cloud provided by an exemplary embodiment of the present application;

FIG. 2 is a schematic logical diagram of a method for expanding a public cloud provided by an exemplary embodiment of the present application;

FIG. 3 is a schematic logical diagram of an exemplary handshake solution provided by an exemplary embodiment of the present application;

FIG. 4 is a schematic logical diagram of a solution of expanding a public cloud provided by an exemplary embodiment of the present application;

FIG. 5 is a schematic logical diagram of a bidirectional transparency solution provided by an exemplary embodiment of the present application;

FIG. 6 is a schematic flowchart of another method for expanding a public cloud provided by an exemplary embodiment of the present application;

FIG. 7 is a schematic structural diagram of a gateway device provided by another exemplary embodiment of the present application;

FIG. 8 is a schematic structural diagram of a physical device provided by yet another exemplary embodiment of the present application;

FIG. 9 is a schematic structural diagram of a system for expanding a public cloud provided by yet another exemplary embodiment of the present application.

### DESCRIPTION OF EMBODIMENTS

In order to make objectives, technical solutions, and advantages of the present application clearer, the technical solutions of the present application will be described clearly and comprehensively in conjunction with specific embodiments of the present application and corresponding accompanying drawings. Obviously, the described embodiments are part of the embodiments of the present application, but not all of the embodiments. Based on the embodiments of the present application, all other embodiments obtained by those of ordinary skill in the art without creative efforts belong to the protection scope of the present application.

At present, there are more and more requirements for expanding a public cloud, and some embodiments of the present application propose that: an expanded available zone is created for the public cloud, and the expanded available zone is deployed in a user machine room, so that a hardware facility of the public cloud is deployed to the user machine room in a software-hardware integration manner, which can meet requirements of users for data security, data local processing, low latency, etc.; by managing the expanded available zone into the public cloud, the users can locally have usage experience that is consistent with that of the public cloud, and the boundary of the public cloud is expanded; taking the expanded available zone as an untrusted environment, identity authentication is performed on a physical device in the expanded available zone through a security gateway deployed in the public cloud, to establish a secure tunnel between the physical device in the expanded available zone and the security gateway, and to strictly verify inbound and outbound traffic between the expanded available zone and the public cloud based on the security gateway, so that the security of the process of expanding the public cloud can be ensured.

The technical solutions provided by the embodiments of the present application are described in detail below with reference to the accompanying drawings.

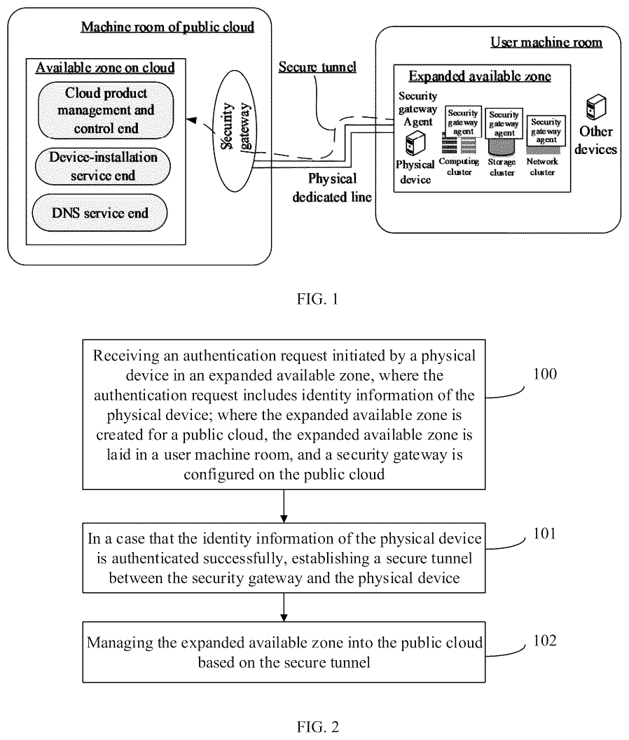

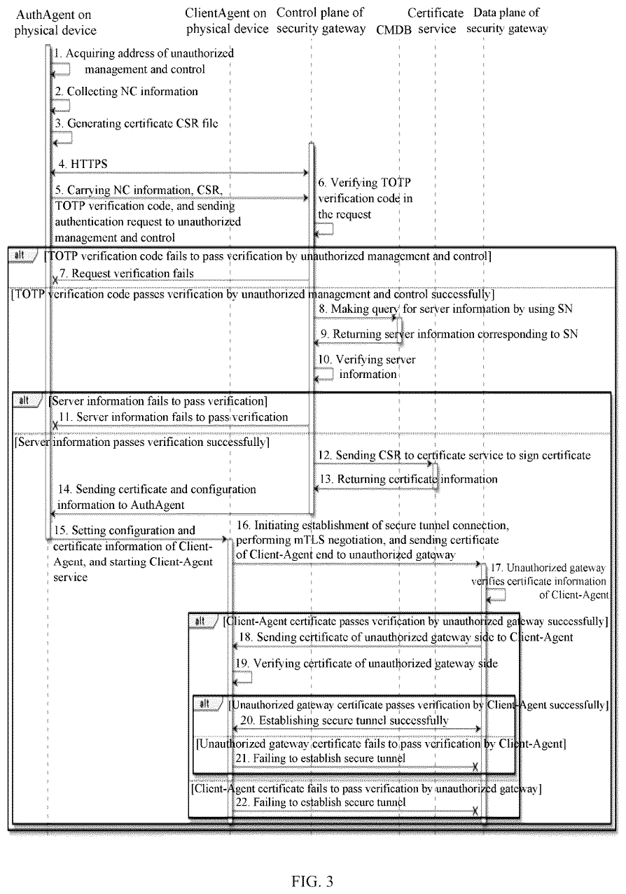

FIG. 1 is a schematic logical diagram of a method for expanding a public cloud provided by an exemplary embodiment of the present application, and FIG. 2 is a schematic logical diagram of a method for expanding a public cloud provided by an exemplary embodiment of the present application. Referring to FIG. 1 and FIG. 2, in this embodiment, an expanded available zone may be created for a public cloud. The expanded available zone is created in the same manner as a traditional available zone in the public cloud, which is not repeated here. A difference between the expanded available zone and the traditional available zone is that the expanded available zone is deployed in a user machine room, while the traditional available zone is usually deployed in a public cloud provider's own machine room.

The technical concepts involved in the embodiments are first explained briefly below.

A public cloud refers to providing an infrastructure, as a service, provided by a public cloud provider to the outside through the Internet. In such a service model, a user does not need to construct a data center by himself/herself, but can use an infrastructure such as a server, a storage, and a network by means of renting. The public cloud is implemented by providing a virtual environment (such as a virtual machine), and a core attribute of the public cloud is that multiple users share a cloud infrastructure and the users are isolated from each other.

Available zones are physical zones within the same region, with power and networks thereof being isolated from each other. An available zone is not affected by failure(s) in other available zone(s). Within a region, different available zones are physically isolated, but internal networks are interconnected, which not only ensures independence of the available zones, but also provides low-cost and low-latency network connections. The traditional available zone and the expanded available zone mentioned above both have common attributes of the available zone mentioned here.

Virtual private network (Virtual Private Cloud, VPC): A VPC is provided in a public cloud, and the VPC is a local area network in a data center on the cloud for users of a public cloud service. Specifically, VPCs isolate virtual networks, and each VPC has an independent tunnel number, with one tunnel number corresponding to one virtual network. Packets between virtual machines within one VPC have the same corresponding tunnel identifier, and are then sent to a physical network for transmission. Since virtual machines within different VPCs are in tunnels with different identifiers, and are located on two different routing planes, the virtual machines within different VPCs cannot conduct communication, thereby naturally achieving logical isolation. Creating a VPC requires specifying a region (region). Multiple available zones may be deployed within one region, and resources within the VPC may be distributed in different available zones. In the embodiments, the expanded available zone may be used as one of available zones in a user VPC, and resources within the VPC may be deployed in the expanded available zone.

It is worth noting that in the embodiments, multiple expanded available zones may be created for the public cloud, and the multiple expanded available zones may be distributed in multiple user machine rooms. For a single user, the expanded available zones distributed in a machine room of the user may be one or more. In practical applications, the expanded available zone(s) distributed in the machine room of the user may be dedicated to the user, so as to ensure the security of user data. Moreover, as mentioned above, the expanded available zone in the user machine room may be used as an available zone in the VPC that the user applies for on the public cloud. Of course, the embodiments do not limit this, and the expanded available zone may not be dedicated to a certain user under other requirements.

For ease of description, the secure expansion solution of the public cloud will be described hereinafter from the perspective of a single expanded available zone. However, it should be understood that the same solution may be adopted for other expanded available zones to ensure the secure expansion of the public cloud.

In addition, in this embodiment, the public cloud may manage the expanded available zone as a fully-hosted and deployable product. For example, a set of cabinets may be used to carry physical devices in the expanded available zone, and these physical devices may include basic devices used for providing services such as computing, storage and network. The user machine room only needs to provide a machine room environment suitable for installation of the expanded available zone. In this embodiment, the physical devices in the expanded available zone may be organized in a cluster manner or in other manners. For example, physical devices in the expanded available zone which provide computing services may be organized as a computing cluster, and physical devices which provide storage services may be organized as a storage cluster, etc. This embodiment does not limit the organizational form, structure and the like of the physical devices in the expanded available zone. For users, they only need to lay the expanded available zone in a local machine room by means of renting on demand, without having to spend a lot of money to purchase related physical devices. For the public cloud, the cost of machine rooms of the public cloud can be reduced, and region requirements of the users can be adapted more flexibly through the expanded available zone.

However, since the expanded available zone is located within the user machine room, for the public cloud, the expanded available zone has risks of, for example, being tampered with, cracked, and attacked by the users, and the expanded available zone may be used as a springboard for performing malicious attacks on the public cloud. Therefore, on the basis of the above public cloud expansion architecture, this embodiment proposes a security protection mechanism to protect management and control of the public cloud and prevent malicious attacks from the user machine room.

Referring to FIG. 1 and FIG. 2, in this embodiment, a security gateway may be deployed in the public cloud. For the security gateway, a method for expanding the public cloud provided by this embodiment may include the following steps.

Step 100: receiving an authentication request initiated by a physical device in the expanded available zone, where the authentication request includes identity information of the physical device.

Step 101: in a case that the identity information of the physical device is authenticated successfully, establishing a secure tunnel between the security gateway and the physical device.

Step 102: managing the expanded available zone into the public cloud based on the secure tunnel.

It should be noted that in this embodiment, a single expanded available zone may include multiple physical devices. For ease of description, a security protection mechanism will be described from the perspective of a single physical device in this embodiment. It should be understood that the security protection mechanism provided in this embodiment may be applied to other physical devices in the expanded available zone.

In this embodiment, dedicated security gateways may be deployed on the public cloud for different user machine rooms, and a security gateway dedicated to a user machine room may be deployed in the same region as the user machine room. For example, when a user machine room is located in Beijing, the security gateway dedicated to the user machine room may also be deployed in Beijing. In practical applications, a public cloud provider may divide regions for a security protection mechanism by means of VPCs, and the public cloud provider may create a VPC for security protection work in a required region. In this way, security gateways respectively dedicated to different user machine rooms in the same region may be distributed in the same VPC, and security gateways respectively dedicated to user machine rooms in different regions may be distributed in different VPCs. For example, the public cloud provider may deploy a VPC in Beijing, where multiple security gateways may be distributed in the VPC, and a single security gateway may be used to manage a certain user machine room located in Beijing. For another example, a security gateway corresponding to a machine room of a certain user located in Beijing will be distributed in a VPC deployed by the public cloud provider in Beijing, and a security gateway corresponding to a machine room of this user in Shanghai will be distributed in a VPC deployed by the public cloud provider in Shanghai. This can effectively improve the response efficiency of the security gateway. In addition, on the public cloud, at least two dedicated security gateways may be allocated to the same user machine room, so as to ensure that the user machine room has a standby security gateway to handle a possible security gateway failure.

In this embodiment, the security gateway may be a boundary gateway additionally deployed on the public cloud for expansion security, so as to add the security protection mechanism on the basis of a solution of accessing through a traditional available zone. The traditional available zone is located in the public cloud provider's own machine room, so the public cloud considers by default that the traditional available zone can be trusted, and there is no need to apply the security protection mechanism of this embodiment to the traditional available zone. It should be understood that network devices such as a router and a switch deployed by the public cloud for accessing through the traditional available zone are also applicable to the expanded available zone. In this embodiment, the security gateway is added on the basis of these existing network devices. For example, the user machine room may access a switch device of the public cloud through a physical dedicated line to establish a physical connection channel between the user machine room and the public cloud.

In this embodiment, a gateway proxy program may be installed on the physical device in the expanded available zone to enable the physical device to cooperate with the security gateway to implement the security protection mechanism according to the relevant logic in FIG. 2. In this embodiment, the gateway proxy program may be integrated into a memory operating system RAMOS of the physical device during a production stage of the expanded available zone, and the RAMOS is a system that may be used to install an operating system. By integrating the gateway proxy program into the RAMOS, it can be ensured that the gateway proxy program can be started before the physical device is installed, thereby ensuring that the device-installation process can be within a security protection range, and avoiding risk problems such as tampering with the operating system of the physical device during the device- installation process. During the device-installation process, the gateway proxy program will be installed into the operating system of the physical device. In this way, during an operation stage of the physical device, the gateway proxy program can be started and operated with the operating system of the physical device, and cooperate with the security gateway on the public cloud to implement the security protection mechanism during operation of services provided by the physical device. In this embodiment, the security protection mechanism can be deployed to each stage of the construction of the expanded available zone based on the gateway proxy program, so that the security protection process is consistent with a deployment operation and maintenance process, thereby eliminating potential security risks caused by the expanded available zone from the root.

Referring to FIG. 2, in step 100, the physical device may initiate the authentication request to the security gateway, where the authentication request may include the identity information of the physical device. The identity information may include but is not limited to a product serial number SN, a channel address OOB MAC, an IP address, a certificate signing request CSR, and an identity verification code generated by performing hash calculation on existing identity information based on a timestamp, etc. The security gateway may perform identity authentication on the physical device based on the identity information of the physical device, and this embodiment does not limit the manner of identity authentication, as long as the identity information of the physical device meets preset identity authentication requirements. Exemplary identity authentication solutions will be provided in subsequent embodiments.

In this embodiment, the public cloud is taken as a trusted environment, and the expanded available zone located in the user machine room is taken as an untrusted environment. The security gateway is deployed between the trusted environment and the untrusted environment, so as to achieve secure mutual access between the untrusted environment and the trusted environment. That is, in this embodiment, the expanded available zone is treated as the untrusted environment, and the public cloud does not trust entities and requests of all networks access from the expanded available zone. All network access from the untrusted environment to the public cloud requires authentication, and data of the public cloud is strictly verified.

In step 101, if the identity information of the physical device is authenticated successfully, the secure tunnel between the security gateway and the physical device may be established. In an implementation, the secure tunnel here may use a VPN tunnel. Communication parties at both ends of the VPN tunnel need to follow a VPN protocol for traffic interaction, and traffic transmission in the VPN tunnel is encrypted. Therefore, after the VPN tunnel is established, the security of the data transmission process in this tunnel can be guaranteed.

In step 102, the expanded available zone may be managed into the public cloud based on the secure tunnel. Here, the meaning of managing is that the secure tunnel is used as a management and control link, and the public cloud can remotely manage and control the expanded available zone located in the user machine room, so as to ensure that the expanded available zone is within the security protection range of the public cloud.

Accordingly, in this embodiment, the expanded available zone is created for the public cloud, and the expanded available zone is deployed in the user machine room, so that a hardware facility of the public cloud is deployed to the user machine room in a software-hardware integration manner, which can meet requirements of users for data security, data local processing, low latency, etc. By managing the expanded available zone into the public cloud, the users can locally have usage experience that is consistent with that of the public cloud, and the boundary of the public cloud is expanded. Taking the expanded available zone as the untrusted environment, the identity authentication is performed on the physical device in the expanded available zone through the security gateway deployed in the public cloud, to establish the secure tunnel between the physical device in the expanded available zone and the security gateway, and to strictly verify inbound and outbound traffic between the expanded available zone and the public cloud based on the security gateway, so that the security of the process of expanding the public cloud can be ensured.

In the embodiments described above or below, the security gateway may use various implementations to perform identity authentication on the physical device.

In an implementation, in response to the authentication request initiated by the physical device, the security gateway may perform a handshake with the physical device. If it is determined in the handshake process that the physical device is a device pre-registered in the public cloud, it is determined that the identity information of the physical device is authenticated successfully, and the secure tunnel between the security gateway and the physical device is established. In this implementation, a configuration management database (CMDB) may be maintained for the public cloud, and information about all devices belonging to the public cloud may be recorded in the database. The devices involved in the database are devices pre-registered in the public cloud. The database may be maintained by the public cloud provider, and the public cloud provider identifies all devices belonging to the public cloud. In this way, after the expanded available zone is laid in the user machine room, the physical device in the expanded available zone may be registered in the public cloud, that is, to be added to the database. In addition, the information of the devices recorded in the database may include but is not limited to a product serial number SN, a product memory, a manufacturer, and other information to describe attributes of various aspects of the devices.

In order to perform the identity authentication on the physical device more objectively, FIG. 3 is a schematic logical diagram of an exemplary handshake solution provided by an exemplary embodiment of the present application. Referring to FIG. 3, the exemplary handshake solution may be:
calculating an identity verification code according to an existing identity parameter included in the identity information of the physical device;
if the identity verification code obtained by calculating is consistent with an identity verification code carried in the identity information of the physical device, detecting whether the physical device is the device pre-registered in the public cloud;
if so, providing an identity certificate to the physical device;
receiving a secure tunnel connecting request initiated by the physical device based on the identity certificate;
in a case that the identity certificate of the physical device passes verification successfully, establishing the secure tunnel between the security gateway and the physical device.

As mentioned above, the identity information included in the authentication request sent by the physical device carries the identity verification code, and the security gateway may use the same calculation manner as the physical device to calculate the identity verification code for the physical device. The security gateway may compare the identity verification code calculated by itself with the identity verification code carried in the authentication request, and if they are consistent, it can be determined that the authentication request is indeed sent by the physical device itself and has not been tampered with. In this way, the legality of the physical device can be double verified through information such as SN, OOBMAC of the physical device, and the identity verification code. On the basis of determining that the physical device is legal, whether the physical device is the device pre-registered in the public cloud can be further verified. Referring to FIG. 3, the security gateway may make a query in the CMDB of the public cloud based on the information such as SN of the physical device, and if the physical device is found in the database by query, it can be determined that the physical device is the device pre-registered in the public cloud.

In this embodiment, a certificate service for the security gateway and the physical device in the expanded available zone may be provided. After determining that the physical device is the device pre-registered in the public cloud, the security gateway may apply for the identity certificate belonging to the physical device from the certificate service and return the identity certificate to the physical device. After receiving the identity certificate, the physical device may initiate the secure tunnel connecting request to the security gateway based on the identity certificate. The security gateway may verify the identity certificate of the physical device, and determine that the secure tunnel connecting request is indeed initiated by the physical device itself, so as to establish the secure tunnel between the security gateway and the physical device. So far, the handshake process is completed. An establishment process of the secure tunnel between the two parties may be based on mutual transport layer security (mTLS) encryption technology.

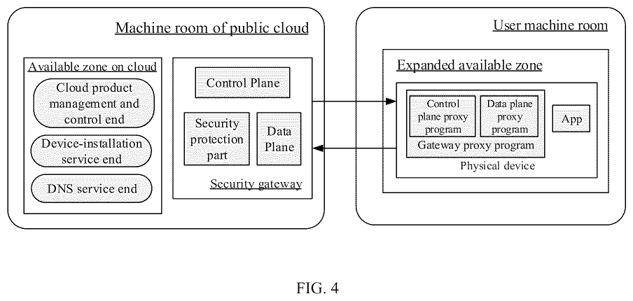

FIG. 4 is a schematic logical diagram of a solution of expanding a public cloud provided by an exemplary embodiment of the present application. In FIG. 4, an exemplary structure of a security gateway is shown.

Referring to FIG. 4, logically, the security gateway may include a control plane, a data plane, and a security protection part. The control plane may be configured to issue a configuration instruction to the data plane, collect a log and heartbeat information of the data plane, etc. The data plane is configured to undertake work of a data transmission layer, such as forwarding, encrypting and decrypting traffic packets, and so on. The security protection part is configured to provide a four-layer/seven-layer protection capability of the security gateway, and the security protection part may adopt web application firewall WAF technology. Based on the security protection part, the security gateway in this embodiment may have the following capabilities.
1) Four-layer protection capability:
providing a four-layer ACL protection capability for source-destination ports and source-destination IPs of two protocols, namely, TCP/UDP, and a four-layer ACL protection capability for source-destination application groups;
providing a four-layer ACL protection capability for address groups or application groups (updating group IPs in time);
recording access request logs and blocking log recording.
2) Seven-layer protection capability:
supporting basic Web protection of http and https, including protection capabilities against attacks such as SQL injection, XSS cross-station, WebSHell uploading, command injection;
supporting custom protection rule configuration for http and https, including custom ACL rules for fields such as URL, Query Arg, User-Agent.

In an implementation, in this embodiment, from a macro perspective, control planes of all security gateways on the public cloud may be centralized, that is, all security gateways may share a control plane, and data planes of the security gateways are deployed in a distributed manner according to regions. Certainly, this is only exemplary, and this embodiment is not limited thereto.

In FIG. 4, an exemplary logical structure of a gateway proxy program installed on a physical device is also shown. Referring to FIG. 4, the gateway proxy program on the physical device may logically include a control plane proxy program and a data plane proxy program. Based on the control plane proxy program, the physical device may be controlled to execute operations such as collecting its own identity information, sending an authentication request to the control plane of the security gateway, etc., and the data plane proxy program may control the physical device to execute operations such as initiating access traffic to the public cloud to the control plane of the security gateway, diverting the access traffic to the secure tunnel, encrypting and encapsulating the access traffic, etc.

Based on the above exemplary structures of the security gateway and the gateway proxy program on the physical device, referring to FIG. 3, an exemplary handshake solution may be specifically as follows.
1. After the gateway proxy program of the physical device is started, the control plane proxy program (hereinafter referred to as AuthAgent) in the gateway proxy program may collect the SN, OOB mac address, IP address information and the like of the physical device, generate a certificate signing request CSR, and generate a TOTP verification code as the identity verification code of the physical device according to a local timestamp and a Hash algorithm. The above information is carried in the authentication request through HTTPS, and is sent to the control plane of the security gateway.
2. The control plane of the security gateway may verify the TOTP verification code in the authentication request, and if the verification is passed, make a query for device information in the CMDB of the public cloud using information such as SN. If it is determined that the physical device is the device pre-registered in the CMDB, a certificate signing request CSR for the physical device may be initiated to the certificate service, and a signed identity certificate is returned to the AuthAgent in the gateway proxy program of the physical device.
3. After receiving the identity certificate, the AuthAgent may configure the identity certificate to the data plane proxy program (hereinafter referred to as ClientAgent) in the gateway proxy program of the physical device, and start the ClientAgent. The ClientAgent may initiate a secure tunnel connecting request to the data plane of the security gateway to perform mTLS negotiation, and exchange identity certificates with the data plane of the security gateway. The two parties may perform mutual verification of identity certificates, in which each party has a root certificate of the other party obtained from the certificate service, and thus has a basis of mutual verification of certificates. In a case that mutual authentication of certificates between the two parties is successful, the two parties may successfully establish the secure tunnel.

Of course, the above handshake solution is exemplary, and this embodiment is not limited thereto.

After completing the handshake process, the secure tunnel is established between the physical device in the expanded available zone and its dedicated security gateway on the public cloud. Interaction traffic of the two parties will be diverted to this secure tunnel, so that all input traffic can be strictly authenticated through the security gateway on the public cloud to ensure the trustworthiness of the input traffic.

In addition, an access control rule corresponding to the physical device in the expanded available zone may also be preset in the security gateway. The access control rule includes a white list of service ends on the public cloud that the physical device is allowed to access. The service ends here may be accessible objects at various levels such as a service, a device or a cluster on the public cloud, and the service end may include but is not limited to a device-installation service end, a domain name system (DNS) service end, a cloud product management and control end, or an application proxy end, etc. The device-installation service end may provide a device-installation service, and the physical device in the expanded available zone may pull data required for device installation by accessing the device-installation service end. The DNS service end may provide a DNS service, and the physical device in the expanded available zone may access the DNS service end to use the DNS service when a domain name resolution requirement occurs. The cloud product management and control end is used to provide a cloud product management and control service, and the physical device in the expanded available zone may initiate a control instruction to the cloud product management and control end to realize management and control over some services on the public cloud. From here, it can be clearly perceived that the physical device in the expanded available zone has a management and control authority over some services on the public cloud, and once the expanded available zone is breached, a huge security loophole will be caused to the public cloud, which is also an original intention of applying the security protection mechanism to the expanded available zone proposed by this embodiment. The application proxy end may be used to provide an application installation service, and the physical device in the expanded available zone may pull data from the application proxy end, so as to install relevant applications on the physical device. It should be understood that the service ends on the public cloud provided here are exemplary, and this embodiment is not limited to these.

Based on this, the security gateway may perform access control on traffic initiated by the physical device for the public cloud, based on the access control rule stored in the security gateway. In practical applications, the security gateway may reject all input traffic from untrusted environments (expanded available zones) by default, and update the white list in the access control rule as needed. In this way, on the one hand, the traffic initiated by the physical device for the public cloud is diverted to the secure tunnel through the gateway proxy program installed on the physical device in the expanded available zone. On the other hand, by presetting the access control rule in the security gateway, it can be ensured that among input traffic from the expanded available zone, only input traffic that meets the access control rule will be allowed to pass. In this embodiment, the security gateway minimizes the exposure of interfaces involving the control plane, such as the cloud product management and control end, in the public cloud to the expanded available zone, thereby reducing the possibility of such structures receiving external attacks as much as possible.

In the embodiments described above or below, the security gateway may use mechanisms such as route publishing and route interception to achieve bidirectional transparency to the expanded available zone and the public cloud.

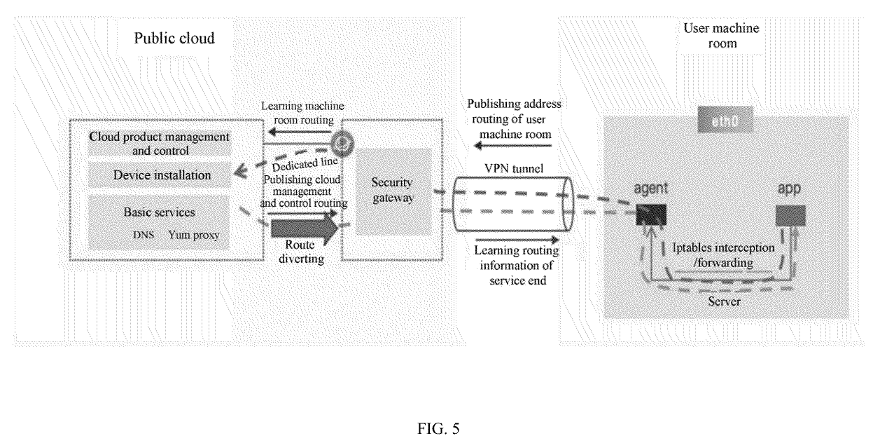

FIG. 5 is a schematic logical diagram of a bidirectional transparency solution provided by an exemplary embodiment of the present application. Referring to FIG. 5, the security gateway may acquire routing information published by the physical device, announce the routing information published by the physical device to the service end on the public cloud, and announce routing information published by the service end to the physical device, where transmission paths indicated by the routing information published by the physical device and the service end both pass through the security gateway.

Referring to FIG. 5, it shows a path of input traffic sent from an application (app) of the physical device in the expanded available zone to the service end on the public cloud (the upper path of the two dotted paths in the figure) and a path of output traffic returned from the service end on the public cloud to the application (app) in the physical device (the lower path of the two dotted paths in the figure). Based on this, the physical device in the expanded available zone may publish an address route of the user machine room to the security gateway, and after learning, the security gateway may publish it to the service end such as the cloud product management and control service end, the DNS service end on the public cloud through a dedicated line. Correspondingly, the service end on the public cloud may publish the routing information of the service end to the physical device in the expanded available zone (specifically to the app in the physical device) through the security gateway. Based on this, the physical device may initiate input traffic to the public cloud according to an address of a required service end, and the gateway proxy program in the physical device may divert the input traffic to the secure tunnel through a Tproxy proxy (by means of IPtables interception/forwarding, etc.). And with the support of network devices such as a router in the expanded available zone, a transmission path of the input traffic may be enabled to pass through the secure gateway according to the routing information published by the service end. In this way, the secure gateway can perform access control on the input traffic according to the access control rule mentioned above to ensure the trustworthiness of the input traffic. Similarly, the output traffic returned by the public cloud to the physical device in the expanded available zone will also be diverted to the secure tunnel, and reach the physical device after encryption, encapsulation and other processing by the secure gateway, which ensures the security of the output traffic. Throughout the entire process, both the physical device and the service end are unaware of the security gateway, and the security gateway is bi-directionally transparent to the expanded available zone and the public cloud.

Accordingly, in this embodiment, the security gateway is bi-directionally transparent to the expanded available zone and the public cloud, so that zero-cost access of the expanded available zone can be realized without address planning and network change, and the expanded available zone can seamlessly access the public cloud. The input traffic from the expanded available zone will be authenticated, authorized, and encrypted by the security gateway to ensure the security and integrity of an access link.

FIG. 6 is a schematic flowchart of another method for expanding a public cloud provided by an exemplary embodiment of the present application. The method for expanding the public cloud shown in FIG. 6 can be applied to a physical device in an expanded available zone. Referring to FIG. 6, the method may include the following steps.

Step 600: initiating, based on a gateway proxy program installed in the physical device, an authentication request to a security gateway configured on the public cloud, where the authentication request includes identity information of the physical device.

Step 601: in a case that the identity information is authenticated successfully, establishing a secure tunnel between the security gateway and the physical device.

Step 602: diverting, based on the gateway proxy program, traffic initiated by the physical device for the public cloud to the secure tunnel to manage the expanded available zone into the public cloud through the secure tunnel.

In an embodiment, the gateway proxy program is integrated into a memory operating system RAMOS of the physical device, and the method further includes:
starting the gateway proxy program before installing the physical device;
after establishing the secure tunnel between the security gateway and the physical device, initiating a device-installation request to a device-installation service end in the public cloud through the secure tunnel to acquire device-installation data from the device-installation service end.

In the aforementioned embodiments related to the solutions of expanding the public cloud described from the security gateway side, the technical logic of the physical device side is also involved. In order to save space, the technical details involved in the solutions of expanding the public cloud from the physical device side can be found in the relevant descriptions in the aforementioned embodiments. These details will not be repeated here, which should not cause loss to the protection scope of the present application.

It should be noted that in some processes described in the above embodiments and the accompanying drawings, multiple operations that appear in a specific order are included. However, it should be clearly understood that these operations may not be executed in the order in which they appear herein or executed in parallel. The serial numbers of the operations, such as 101, 102, etc., are only used to distinguish different operations, and the serial numbers themselves do not represent any execution order. In addition, these processes may include more or fewer operations, and these operations may be executed sequentially or in parallel.

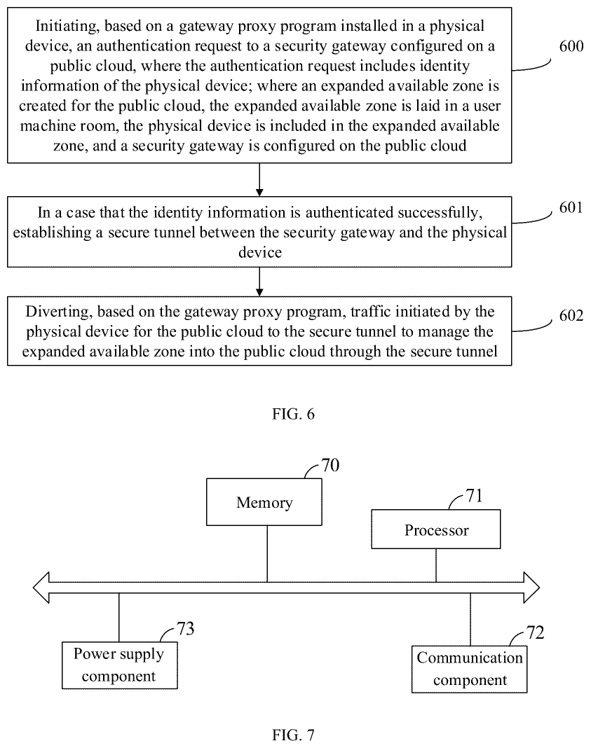

FIG. 7 is a schematic structural diagram of a gateway device provided by another exemplary embodiment of the present application. As shown in FIG. 7, the gateway device is deployed in a public cloud, and an expanded available zone is created for the public cloud. The expanded available zone is laid in a user machine room. The gateway device includes a memory 70, a processor 71, and a communication component 72;
the memory 70 is configured to store one or more computer instructions;
the processor 71 is coupled to the memory 70 and the communication component 72, and is configured to execute the one or more computer instructions to:
receive an authentication request initiated by a physical device in the expanded available zone through the communication component 72, where the authentication request includes identity information of the physical device;
in a case that the identity information of the physical device is authenticated successfully, establish a secure tunnel between the security gateway and the physical device;
manage the expanded available zone into the public cloud based on the secure tunnel.

In an embodiment, in a process of establishing the secure tunnel between the security gateway and the physical device in the case that the identity information of the physical device is authenticated successfully, the processor 71 may be configured to:
in response to the authentication request, perform a handshake with the physical device;
if it is determined in a handshake process that the physical device is a device pre-registered in the public cloud, establish the secure tunnel between the security gateway and the physical device.

In an embodiment, in the handshake process, the processor 71 may be configured to:
calculate an identity verification code according to an identity parameter included in the identity information of the physical device;
if the identity verification code obtained by calculating is consistent with an identity verification code carried in the identity information of the physical device, detect whether the physical device is the device pre-registered in the public cloud;
if so, provide an identity certificate to the physical device;
receive a secure tunnel connecting request initiated by the physical device based on the identity certificate;
in a case that the identity certificate of the physical device passes verification successfully, establish the secure tunnel between the security gateway and the physical device.

In an embodiment, the identity information includes one or more of a product serial number SN, a channel address OOB MAC, an IP address, a certificate signing request CSR, or an identity verification code generated by performing hash calculation on an existing identity parameter in the identity information according to a timestamp.

In an embodiment, after managing the expanded available zone into the public cloud, the processor 71 may be further configured to:
perform access control on traffic initiated by the physical device for the public cloud based on an access control rule stored in the security gateway;
where the access control rule includes a white list of service ends on the public cloud that the physical device is allowed to access.

In an embodiment, the processor 71 may be further configured to:
acquire routing information published by the physical device;
announce the routing information published by the physical device to a service end on the public cloud;
announce routing information published by the service end to the physical device;
where transmission paths indicated by the routing information published by the physical device and the service end both pass through the security gateway.

In an embodiment, the service end includes one or more of a device-installation service end, a DNS service end, a cloud product management and control end, or an application proxy end.

Further, as shown in FIG. 7, the gateway device further includes other components such as a power supply component 73. FIG. 7 only schematically shows some components, which does not mean that the gateway device includes only the components shown in FIG. 7.

It is worth noting that the technical details of the various embodiments of the gateway device mentioned above can be found in the relevant descriptions of the security gateway in the aforementioned method embodiments. These details will not be repeated here in order to save space, which should not cause loss to the protection scope of the present application.

FIG. 8 is a schematic structural diagram of a physical device provided by yet another exemplary embodiment of the present application. Referring to FIG. 8, an expanded available zone is created for a public cloud, and the expanded available zone is laid in a user machine room. The physical device is located in the expanded available zone, and the physical device includes a memory 80, a processor 81, and a communication component 82;
the memory 80 is configured to store one or more computer instructions for gateway proxy;
the processor 81 is coupled to the memory 80 and the communication component 82, and is configured to execute the one or more computer instructions to:
initiate, based on a gateway proxy program installed in the physical device, an authentication request to a security gateway configured on the public cloud, where the authentication request includes identity information of the physical device;
in a case that the identity information is authenticated successfully, establish a secure tunnel between the security gateway and the physical device;
divert, based on the gateway proxy program, traffic initiated by the physical device for the public cloud to the secure tunnel to manage the expanded available zone into the public cloud through the secure tunnel.

In an embodiment, the gateway proxy program is integrated into a memory operating system RAMOS of the physical device, and the processor 81 may be further configured to:
start the gateway proxy program before installing the physical device;
after establishing the secure tunnel between the security gateway and the physical device, initiate a device-installation request to a device-installation service end in the public cloud through the secure tunnel to acquire device-installation data from the device-installation service end.

Further, as shown in FIG. 8, the physical device further includes other components such as a power supply component 83. FIG. 8 only schematically shows some components, which does not mean that the physical device includes only the components shown in FIG. 8.

It is worth noting that the technical details of the various embodiments of the physical device mentioned above can be found in the relevant descriptions of the physical device in the aforementioned method embodiments. These details will not be repeated here in order to save space, which should not cause loss to the protection scope of the present application.

Correspondingly, an embodiment of the present application further provides a computer-readable storage medium storing a computer program, and the steps that can be executed by the gateway device or the physical device in the above method embodiments can be implemented when the computer program is executed.

The memory shown in FIG. 7 and FIG. 8 is configured to store a computer program and can be configured to store various other data to support operations on a computing platform. Examples of the data include instructions for any application or method used to operate on the computing platform, contact data, phonebook data, messages, images, videos, etc. The memory may be implemented by any type of volatile or non-volatile storage devices or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic storage, a flash memory, a magnetic disk or an optical disk.

The communication component in FIG. 7 and FIG. 8 is configured to facilitate wired or wireless communication between a device where the communication component is located and other devices. The device where the communication component is located may access a wireless network based on a communication standard, such as WiFi, 2G, 3G, 4G/LTE, or 5G, or a combination thereof. In an exemplary embodiment, the communication component receives a broadcast signal or broadcast related information from an external broadcast management system via a broadcast channel. In an exemplary embodiment, the communication component also includes a near field communication (NFC) module to facilitate short-range communication. For example, the NFC module may be implemented based on radio frequency identification (RFID) technology, infrared data association (IrDA) technology, ultra wideband (UWB) technology, Bluetooth (BT) technology, and other technologies.

The power supply component in FIG. 7 and FIG. 8 supplies power to various components of a device where the power supply component is located. The power supply component may include a power management system, one or more power supplies, and other components associated with generating, managing, and distributing power for the device where the power supply component is located.

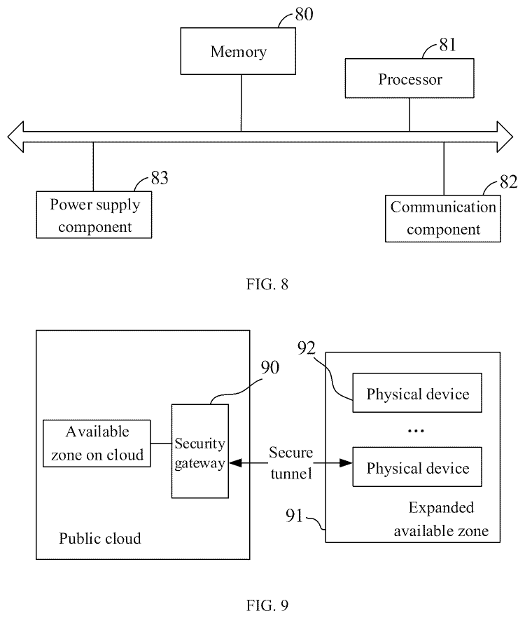

FIG. 9 is a schematic structural diagram of a system for expanding a public cloud provided by yet another exemplary embodiment of the present application. Referring to FIG. 9, the system may include a security gateway 90 and an expanded available zone 91 created for the public cloud, where the security gateway 90 is deployed in the public cloud, and the expanded available zone 91 is laid in a user machine room;
a physical device 92 in the expanded available zone 91 is configured to initiate an authentication request to the security gateway 90 configured on the public cloud based on a gateway proxy program installed in the physical device 92, where the authentication request includes identity information of the physical device 92;
the security gateway 90 is configured to: receive the authentication request; in a case that the identity information of the physical device 92 is authenticated successfully, establish a secure tunnel between the security gateway 90 and the physical device 92; and manage the expanded available zone 91 into the public cloud based on the secure tunnel.

In an embodiment, the physical device 92 in the expanded available zone 91 is further configured to:
in the case that the identity information is authenticated successfully, establish the secure tunnel between the security gateway 90 and the physical device 92;
divert, based on the gateway proxy program, traffic initiated by the physical device 92 for the public cloud to the secure tunnel to manage the expanded available zone 91 into the public cloud through the secure tunnel.

In an embodiment, the gateway proxy program is integrated into a memory operating system RAMOS of the physical device 92, and the physical device 92 may be further configured to:
start the gateway proxy program before installing the physical device 92;
after establishing the secure tunnel between the security gateway 90 and the physical device 92, initiate a device-installation request to a device-installation service end in the public cloud through the secure tunnel to acquire device-installation data from the device-installation service end.

In an embodiment, in a process of establishing the secure tunnel between the security gateway 90 and the physical device 92 in the case that the identity information of the physical device 92 is authenticated successfully, the security gateway 90 may be configured to:
in response to the authentication request, perform a handshake with the physical device 92;
if it is determined in a handshake process that the physical device 92 is a device pre-registered in the public cloud, establish the secure tunnel between the security gateway 90 and the physical device 92.

In an embodiment, in the handshake process, the security gateway 90 may be configured to:
calculate an identity verification code according to an identity parameter included in the identity information of the physical device 92;
if the identity verification code obtained by calculating is consistent with an identity verification code carried in the identity information of the physical device 92, detect whether the physical device 92 is the device pre-registered in the public cloud;
if so, provide an identity certificate to the physical device 92;
receive a secure tunnel connecting request initiated by the physical device 92 based on the identity certificate;
in a case that the identity certificate of the physical device 92 passes verification successfully, establish the secure tunnel between the security gateway 90 and the physical device 92.

In an embodiment, the identity information includes one or more of a product serial number SN, a channel address OOB MAC, an IP address, a certificate signing request CSR, or an identity verification code generated by performing hash calculation on an existing identity parameter in the identity information according to a timestamp.

In an embodiment, after managing the expanded available zone 91 into the public cloud, the security gateway 90 may be further configured to:
perform access control on traffic initiated by the physical device 92 for the public cloud based on an access control rule stored in the security gateway 90;
where the access control rule includes a white list of service ends on the public cloud that the physical device 92 is allowed to access.

In an embodiment, the security gateway 90 may be further configured to:
acquire routing information published by the physical device 92;
announce the routing information published by the physical device 92 to a service end on the public cloud;
announce routing information published by the service end to the physical device 92;
where transmission paths indicated by the routing information published by the physical device 92 and the service end both pass through the security gateway.

In an embodiment, the service end includes one or more of a device-installation service end, a DNS service end, a cloud product management and control end, or an application proxy end.

It is worth noting that the technical details of the various embodiments of the system for expanding the public cloud mentioned above can be found in the relevant descriptions of the physical device and the security gateway in the aforementioned method embodiments. These details will not be repeated here in order to save space, which should not cause loss to the protection scope of the present application.

Those skilled in the art should understand that embodiments of the present application may be provided as a method, a system, or a computer program product. Therefore, the present application may take a form of an embodiment entirely in hardware, an embodiment entirely in software, or an embodiment combining software and hardware aspects. Moreover, the present application may take a form of a computer program product implemented on one or more computer usable storage media (including but not limited to a disk memory, a CD-ROM, an optical memory, etc.) including computer usable program code.

The present application is described with reference to flowcharts and/or block diagrams of the methods, devices (systems), and computer program products according to the embodiments of the present application. It should be understood that each flow and/or block in the flowcharts and/or block diagrams, and combinations of flows and/or blocks in the flowcharts and/or block diagrams may be implemented by computer program instructions. These computer program instructions may be provided to a processor of a general-purpose computer, a special-purpose computer, an embedded processor, or other programmable data processing devices to generate a machine, so that the instructions executed by the processor of the computer or the other programmable data processing devices generate an apparatus for implementing functions specified in one or more flows of the flowcharts and/or one or more blocks of the block diagrams.

These computer program instructions may also be stored in a computer-readable memory that can guide the computer or the other programmable data processing devices to work in a specific manner, so that the instructions stored in the computer-readable memory generate a manufactured product including an instruction apparatus, and the instruction apparatus implements functions specified in one or more flows of the flowcharts and/or one or more blocks of the block diagrams.

These computer program instructions may also be loaded onto the computer or the other programmable data processing devices, so that a series of operation steps are executed on the computer or the other programmable devices to generate computer-implemented processing, and thus the instructions executed on the computer or the other programmable devices provide steps for implementing functions specified in one or more flows of the flowcharts and/or one or more blocks of the block diagrams.

In a typical configuration, a communication device includes one or more processors (CPUs), an input/output interface, a network interface, and a memory.

The memory may include a non-permanent memory, such as a random access memory (RAM), and/or a non-volatile memory, such as read-only memory (ROM) or a flash memory (flash RAM), in computer-readable media. The memory is an example of a computer-readable medium.

The computer-readable media, including permanent and non-permanent, removable and non-removable media, may implement information storage by any method or technology. Information may be computer-readable instructions, data structures, modules of programs, or other data. Examples of storage media for computers include, but are not limited to, a phase change memory (PRAM), a static random access memory (SRAM), a dynamic random access memory (DRAM), other types of random access memory (RAM), a read-only memory (ROM), an electrically erasable programmable read-only memory (EEPROM), a flash memory or other memory technologies, a compact disk read-only memory (CD-ROM), a digital versatile disk (DVD) or other optical storage, a magnetic cartridge, a magnetic disk storage or other magnetic storage devices, or any other non-transmission media that may be used to store information that can be accessed by computing devices. According to the definition herein, the computer-readable media do not include transitory computer-readable media (transitory media), such as modulated data signals and carriers.

It should also be noted that terms “including”, “comprising”, or any other variation thereof are intended to cover non-exclusive inclusion, such that a process, method, commodity or device including a series of elements not only includes those elements, but also includes other elements that are not explicitly listed, or also includes elements inherent to such process, method, commodity or device. Without further limitations, an element defined by a statement “including a/an . . . ” does not exclude the existence of other identical elements in the process, method, commodity or device including that element.

Those described above are only embodiments of the present application, and are not intended to limit the present application. For those skilled in the art, the present application may have various modifications and variations. Any modifications, equivalent substitutions, improvements, etc., made within the spirit and principles of the present application, shall be included within the protection scope of the present application.

1. A method for expanding a public cloud, wherein an expanded available zone is created for the public cloud, the expanded available zone is laid in a user machine room, and a security gateway is configured on the public cloud; the method is applicable to the security gateway, and comprises:
receiving an authentication request initiated by a physical device in the expanded available zone, wherein the authentication request comprises identity information of the physical device;
in a case that the identity information of the physical device is authenticated successfully, establishing a secure tunnel between the security gateway and the physical device; and
managing the expanded available zone into the public cloud based on the secure tunnel.

2. The method according to claim 1, wherein in the case that the identity information of the physical device is authenticated successfully, establishing the secure tunnel between the security gateway and the physical device comprises:
in response to the authentication request, performing a handshake with the physical device; and
if it is determined in a handshake process that the physical device is a device pre-registered in the public cloud, establishing the secure tunnel between the security gateway and the physical device.

3. The method according to claim 2, wherein the handshake process comprises:
calculating an identity verification code according to an identity parameter comprised in the identity information of the physical device;
if the identity verification code obtained by calculating is consistent with an identity verification code carried in the identity information of the physical device, detecting whether the physical device is the device pre-registered in the public cloud;
if so, providing an identity certificate to the physical device;
receiving a secure tunnel connecting request initiated by the physical device based on the identity certificate; and
in a case that the identity certificate of the physical device passes verification successfully, establishing the secure tunnel between the security gateway and the physical device.

4. The method according to claim 1, wherein the identity information comprises one or more of a product serial number (SN), a channel address, an Internet protocol (IP) address, a certificate signing request (CSR), or an identity verification code generated by performing hash calculation on an existing identity parameter in the identity information according to a timestamp.

5. The method according to claim 1, after managing the expanded available zone into the public cloud, further comprising:
performing access control on traffic initiated by the physical device for the public cloud based on an access control rule stored in the security gateway;
wherein the access control rule comprises a white list of service ends on the public cloud that the physical device is allowed to access.

6. The method according to claim 1, further comprising:
acquiring routing information published by the physical device;
announcing the routing information published by the physical device to a service end on the public cloud; and
announcing routing information published by the service end to the physical device;
wherein transmission paths indicated by the routing information published by the physical device and the service end both pass through the security gateway.

7. The method according to claim 6, wherein the service end comprises one or more of a device-installation service end, a domain name system (DNS) service end, a cloud product management and control end, or an application proxy end.

8. A method for expanding a public cloud, wherein an expanded available zone is created for the public cloud, the expanded available zone is laid in a user machine room, and a security gateway is configured on the public cloud; the method is applicable to a physical device in the expanded available zone, and comprises:
initiating, based on a gateway proxy program installed in the physical device, an authentication request to the security gateway configured on the public cloud, wherein the authentication request comprises identity information of the physical device;
in a case that the identity information is authenticated successfully, establishing a secure tunnel between the security gateway and the physical device; and
diverting, based on the gateway proxy program, traffic initiated by the physical device for the public cloud to the secure tunnel to manage the expanded available zone into the public cloud through the secure tunnel.

9. The method according to claim 8, wherein the gateway proxy program is integrated into a memory operating system of the physical device, and the method further comprises:
starting the gateway proxy program before installing the physical device; and
after establishing the secure tunnel between the security gateway and the physical device, initiating a device-installation request to a device-installation service end in the public cloud through the secure tunnel to acquire device-installation data from the device-installation service end.

10. A gateway device, deployed in a public cloud, wherein an expanded available zone is created for the public cloud, the expanded available zone is laid in a user machine room, and the gateway device comprises;
a memory;
a processor; and
a communication component;
the memory is configured to store one or more computer instructions, and
the processor is coupled to the memory and the communication component, and is configured to execute the one or more computer instructions to implement the method according to claim 1.

11. A physical device, wherein an expanded available zone is created for a public cloud, and the expanded available zone is laid in a user machine room; the physical device is located in the expanded available zone, and the physical device comprises:
a memory;
a processor; and
a communication component,
the memory is configured to store one or more computer instructions for gateway proxy, and
the processor is coupled to the memory and the communication component, and is configured to execute the one or more computer instructions to implement the method according to claim 8.

12. A system for expanding a public cloud, comprising a security gateway and an expanded available zone created for the public cloud, wherein the security gateway is deployed in the public cloud, and the expanded available zone is laid in a user machine room;
a physical device in the expanded available zone is configured to initiate an authentication request to the security gateway configured on the public cloud based on a gateway proxy program installed in the physical device, wherein the authentication request comprises identity information of the physical device;
the security gateway is configured to: receive the authentication request; in a case that the identity information of the physical device is authenticated successfully, establish a secure tunnel between the security gateway and the physical device; and manage the expanded available zone into the public cloud based on the secure tunnel.

13. A non-transitory computer-readable storage medium storing computer instructions, wherein when the computer instructions are executed by one or more processors, the one or more processors are caused to execute the method for expanding the public cloud according to claim 1.

14. The gateway device according to claim 10, wherein the processor is configured to:
in response to the authentication request, perform a handshake with the physical device; and
if it is determined in a handshake process that the physical device is a device pre-registered in the public cloud, establish the secure tunnel between the security gateway and the physical device.

15. The gateway device according to claim 14, wherein the handshake process comprises:
calculating an identity verification code according to an identity parameter comprised in the identity information of the physical device;
if the identity verification code obtained by calculating is consistent with an identity verification code carried in the identity information of the physical device, detecting whether the physical device is the device pre-registered in the public cloud;
if so, providing an identity certificate to the physical device;
receiving a secure tunnel connecting request initiated by the physical device based on the identity certificate; and
in a case that the identity certificate of the physical device passes verification successfully, establishing the secure tunnel between the security gateway and the physical device.

16. The gateway device according to claim 10, wherein the identity information comprises one or more of a product serial number (SN), a channel address, an Internet protocol (IP) address, a certificate signing request (CSR), or an identity verification code generated by performing hash calculation on an existing identity parameter in the identity information according to a timestamp.

17. The gateway device according to claim 10, wherein the processor is further configured to:
perform access control on traffic initiated by the physical device for the public cloud based on an access control rule stored in the security gateway,
wherein the access control rule comprises a white list of service ends on the public cloud that the physical device is allowed to access.

18. The gateway device according to claim 10, wherein the processor is further configured to:
acquire routing information published by the physical device;
announce the routing information published by the physical device to a service end on the public cloud; and
announce routing information published by the service end to the physical device;
wherein transmission paths indicated by the routing information published by the physical device and the service end both pass through the security gateway.

19. The gateway device according to claim 18, wherein the service end comprises one or more of a device-installation service end, a domain name system (DNS) service end, a cloud product management and control end, or an application proxy end.

20. The physical device according to claim 11, wherein the gateway proxy program is integrated into a memory operating system of the physical device, and the processor is configured to:
start the gateway proxy program before installing the physical device; and
after establishing the secure tunnel between the security gateway and the physical device, initiate a device-installation request to a device-installation service end in the public cloud through the secure tunnel to acquire device-installation data from the device-installation service end.
